(19) United States
(12) Patent Application Publication
(10) Pub. No.: US 2006/0087864 A1
(43) Pub. Date: Apr. 27, 2006

(54) Illuminating textile device

(76) Inventors: Chi-Tsung Peng, Hsinchu City (TW); Sheng-Te Liu, Gangshan Township (TW); Ching-Shan Wang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/038,219

(22) Filed: Jan. 21, 2005

(30) Foreign Application Priority Data
Oct. 26, 2004 (TW) 93132407

(51) Int. Cl. G02B 6/08

(52) U.S. Cl. 362/554; 362/556; 362/555

(57) ABSTRACT

The present invention relates to an illuminating textile device. The illuminating textile device has a panel, a optical fabric, and a base. The panel has a transparent area and a non-transparent area. The optical fabric is woven from fiber optics and threads for providing the light source. The base is attached to the panel by a fixation component. The optical fabric is located between the panel and the base.

### RELATED APPLICATIONS

The present application is based on, and claims priority from, Taiwan Application Serial Number 93132407, filed Oct. 26, 2004, the disclosure of which is hereby incorporated by reference herein in its entirety.

### BACKGROUND

1. Field of Invention

The present invention relates to an illuminating textile device. More particularly, the present invention relates to an illuminating textile device utilizing fiber optics as a light source.

2. Description of Related Art

Conventionally, illuminating devices can be classified into two categories. One type is a passive reflective illuminating device, which is illuminated by reflecting light from other external light sources. Light from the external light sources is reflected by reflective material coated on the passive reflective illuminating device. One example of the passive reflective illuminating devices is a traffic sign, which reflects light from headlights. However, for the passive reflective illuminating devices, the illumination intensity is mainly determined by the light from external light sources. If the light intensity of the external light sources is insufficient, the illumination intensity of the passive reflective illuminating devices also diminishes. For example, the light from the headlight may not be sufficient for clear reading of the traffic sign. Unclear traffic signs may further result in catastrophic car accidents.

The other type is an active illuminating device, which illuminates by an internal light source, such as fluorescent lamps. One example of the active illuminating devices is a neon sign. However, for an active illuminating device, lifetime is largely dependent upon the internal light sources employed. For example, a decay phenomenon occurs frequently when fluorescent lamps are employed as the internal light sources. Decay results in diminished light intensity and lifetime of the fluorescent lamps. Therefore, routine maintenance and replacement is required for most active illuminating devices. Furthermore, conventional active illuminating devices are usually bulky, and the applications thereof are restricted.

### SUMMARY

It is therefore an objective of the present invention to provide an illuminating textile device with enhanced illumination intensity, sustained lifetime, and decreased volume.

In accordance with the foregoing and other objectives of the present invention, an illuminating textile device is provided. The illuminating textile device comprises a panel, an optical fabric, and a base. The panel comprises a transparent area and a non-transparent area. The optical fabric is woven from fiber optics and thread for providing the light source. The base is attached to the panel by a fixation component. The optical fabric is located between the panel and the base.

The illuminating textile device according to the present invention has a sustained lifetime and decreased volume, and can be employed in various applications, such as traffic signs, indicators, license plates, route signs, doorplates, decorations, signboards, neon lamps, kites, or toys.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A is a diagram illustrating the arrangement of fiber optics and threads of the optical fabric according to the present invention, in which the fiber optics are arranged horizontally, and the threads are arranged vertically;

FIG. 1B is a diagram illustrating the arrangement of fiber optics and threads of the optical fabric according to the present invention, in which the fiber optics and threads are arranged horizontally, and the threads are arranged vertically;

FIG. 1C is a diagram illustrating the arrangement of fiber optics and threads of the optical fabric according to the present invention, in which the fiber optics and threads are arranged horizontally, and the threads are arranged vertically;

FIG. 2A is a top view diagram of the illuminating textile device according to the first preferred embodiment of the present invention;

FIG. 2B is an assembly diagram of the illuminating textile device according to the first preferred embodiment of the present invention;

FIG. 3A is a top view diagram of the illuminating textile device according to the second preferred embodiment of the present invention;

FIG. 3B is an assembly diagram of the illuminating textile device according to the second preferred embodiment of the present invention;

FIG. 4A is a top view diagram of the illuminating textile device according to the third preferred embodiment of the present invention; and

FIG. 4B is an assembly diagram of the illuminating textile device according to the third preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention provides an active illuminating textile device utilizing optical fabric as a light source. Compared with the conventional active illuminating devices, the illuminating textile device according to the present invention has the advantages of sustained lifetime and reduced volume.

The illuminating textile device according to the present invention comprises a panel, an optical fabric, and a base. The panel comprises a transparent area and a non-transparent area. By appropriately arranging the transparent area and the non-transparent area, a pattern to be displayed can be formed. The panel can be made of plastic or metal. For example, when the panel is made of acrylic, the pattern can be formed by injection molding, screen printing, computer-molding, or pasting, or from plastic materials with different colors. Alternatively, when the panel is made of metal, the pattern can be formed by laser cutting or stamping.

The optical fabric is woven from fiber optics and threads. The threads can be reflective yarn or transparent yarn. The optical fabric woven from fiber optics and threads has improved illumination intensity due to the enhanced reflection. from the reflective yarn or transparent yarn. Further, compared with the illuminating device merely employing fiber optics, the optical fabric can magnify and homogenize the light emitted by the fiber optics. Furthermore, the optical fabric can be woven on a conventional weaving machine, and mass production becomes feasible.

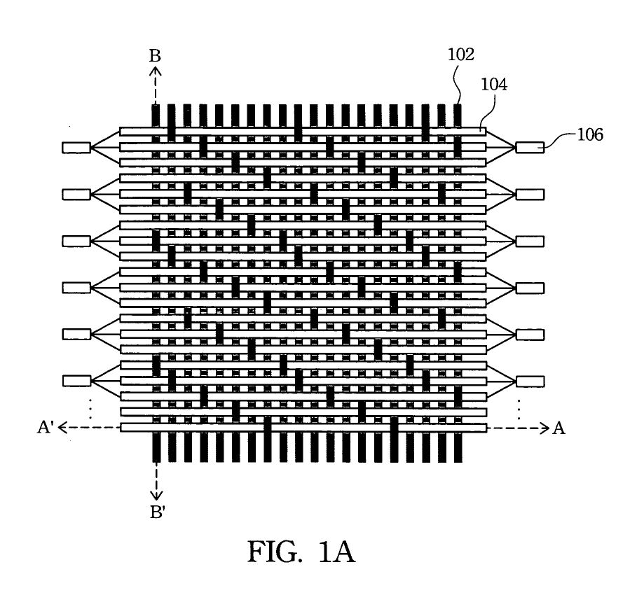

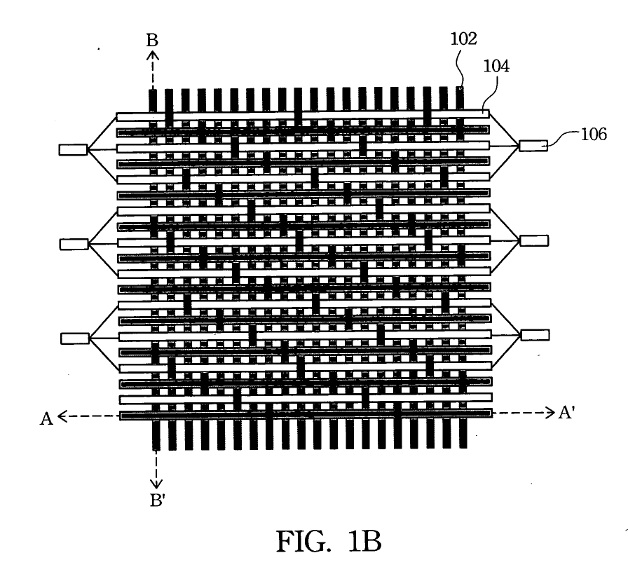

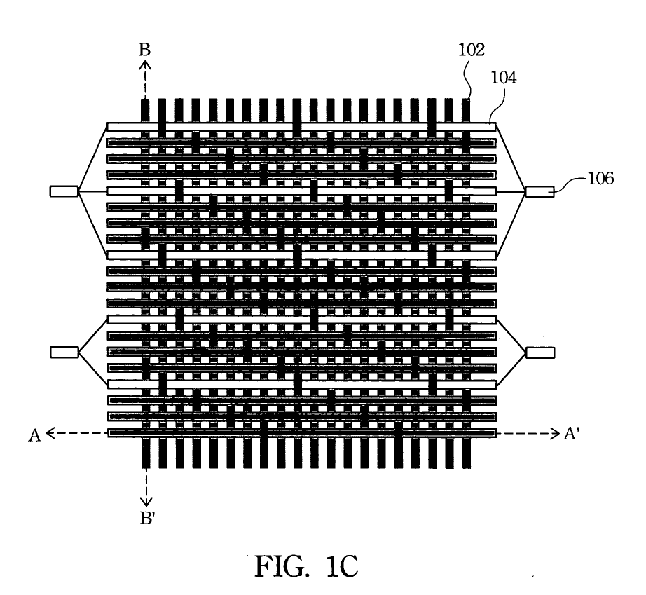

The optical fabric can be woven from fiber optics and threads with different arrangements. FIG. 1A to FIG. 1C demonstrate different arrangements of the fiber optics and the threads of the optical fabric. As shown in FIG. 1A, the arrowheads from A to A′ represent a horizontal direction, while the arrowheads from B to B′ represent a vertical direction. In the horizontal direction, the optical fabric is purely comprised of the fiber optics 104, while, in the vertical direction, the optical fabric is purely comprised of the threads 102. Several fiber optics 104 merge into a bundle 106, and provide LEDs in the bundle as a light source to the fiber optics.

Furthermore, the threads 102 and the fiber optics 104 can be arranged in an alternating pattern. As shown in FIG. 1B, in the horizontal direction, the optical fabric is comprised of both threads 102 and the fiber optics 104, and each thread 102 is adjacent to the fiber optic 104. In the vertical direction, the optical fabric is solely comprised of threads. Similarly, several fiber optics 104 merge into a bundle 106. Furthermore, as shown in FIG. 1C, in the horizontal direction, the optical fabric is also comprised of the threads 102 and the fiber optics 104, but each thread 102 is adjacent to more than one fiber optic 104. Various arrangements can be adapted to create different display effects. For example, when the proportion of the fiber optics increases, the illumination intensity of the optical fabric also increases.

The base is used for supporting the panel and the optical fabric, and attached to the panel by a fixation component. The optical fabric is located between the panel and the base. The fixation component can be designed to be easily removed, thereby allowing a user to user to replace conveniently the panels with different patterns. The fixation component can be screws, sliding-slots, buckles, bolts, buttons, or Velcro. Further, the optical fabric can be powered by an AC source or a battery module, such as a dry battery or a solar battery.

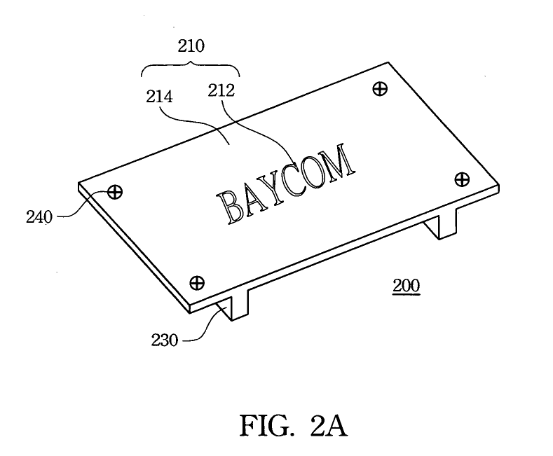

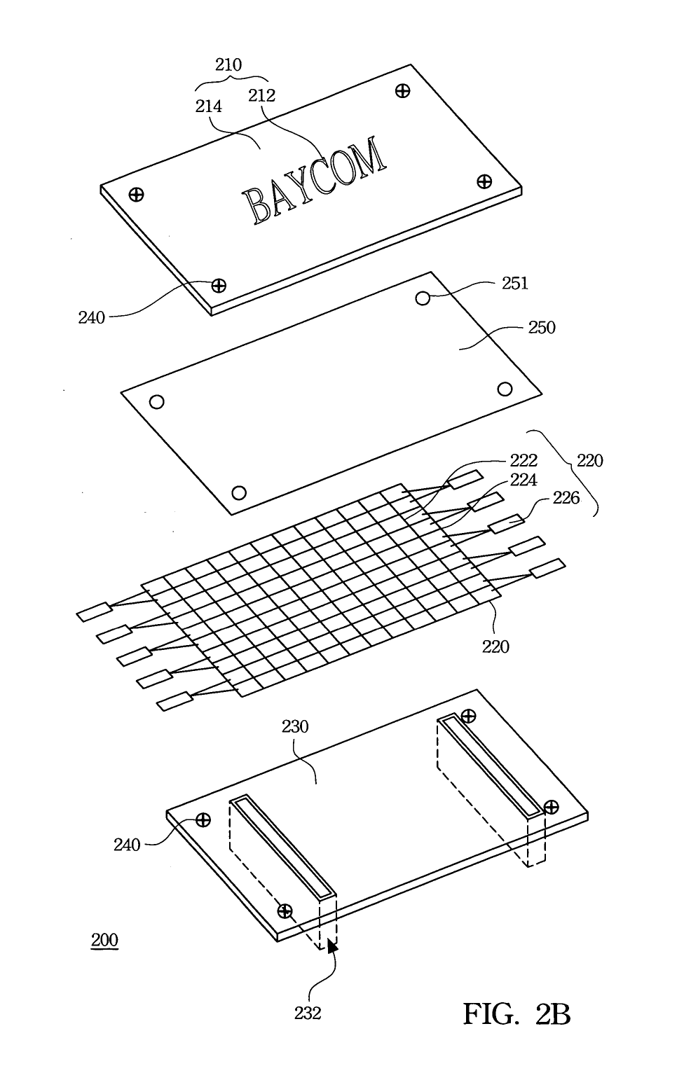

FIG. 2A and FIG. 2B illustrate an illuminating textile device according to the first preferred embodiment of the present invention. The illuminating textile device according to the present invention can be employed in various applications, such as traffic signs, indicators, license plates, route signs, doorplates, decorations, signboards, neon lamps, kites, or toys. FIG. 2A is a top view diagram of the illuminating textile device 200 according to the first preferred embodiment of the present invention. The illuminating textile device comprises a panel 210, a base 230, screws 240, a optical fabric 220 and an immobilizing slab 250 shown in FIG. 2B. The panel 210 is attached to the base 230 by the screws 240. The panel 210 comprises a transparent area 212 and a non-transparent area 214. The transparent area 212 forms the pattern to be displayed. FIG. 2B is an assembly diagram of the illuminating textile device 200. The optical fabric 220 is located between the panel 210 and the base 230, and is woven from threads 222 and fiber optics 224. Several fiber optics 224 merge into a bundle 226, and provide the bundle 226 with LEDs as a light source for the fiber optics 224. The bundle 226 is further connected to a switch and an AC source or a battery module, such as a dry battery or a solar battery. The bundle 226 can be accommodated in the trench 232 of the base 230.

Moreover, an immobilizing slab 250 can be placed between the panel 210 and optical fabric 220 for immobilizing the optical fabric 220 on the base 230. The immobilizing slab 250 prevents the optical fabric 220 from sliding on the base 230. The immobilizing slab 250 is fastened on the base 230 through the screw holes 251 by the screws 240.

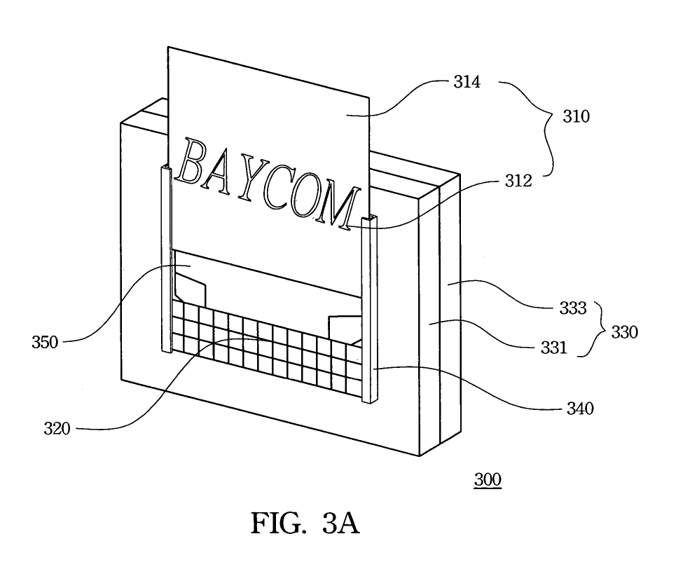

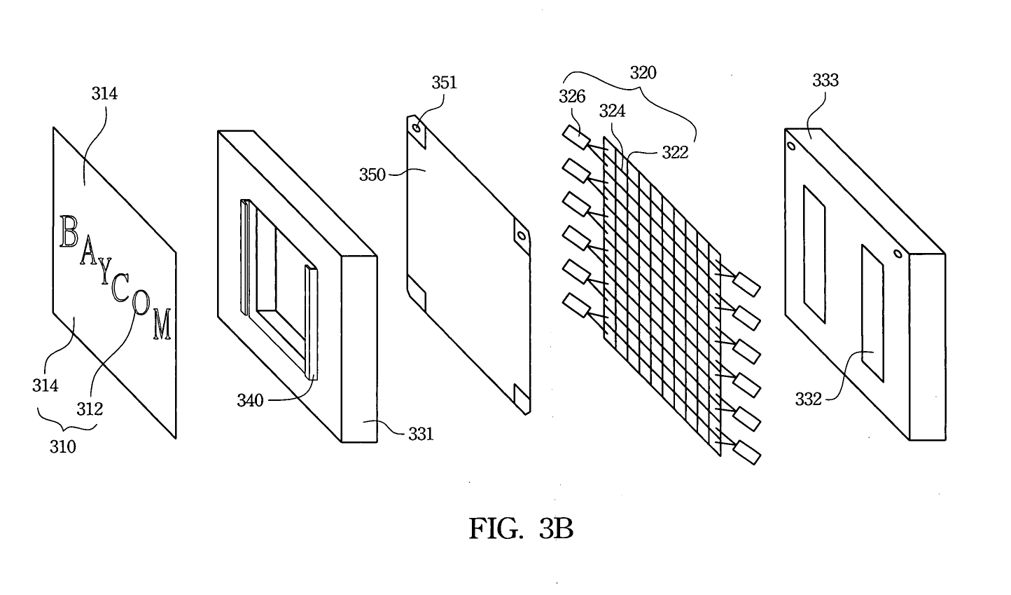

FIG. 3A and FIG. 3B illustrate an illuminating textile device according to second preferred embodiment of the present invention. The illuminating textile device according to the second preferred embodiment of the present invention can be employed in various applications, such as traffic signs, indicators, license plates, route signs, doorplates, decorations, signboards, neon lamps, kites, or toys. FIG. 3A is a top view diagram of the illuminating textile device 300 according to a second preferred embodiment of the present invention. The illuminating textile device 300 comprises a panel 310, an optical fabric 320, a base 330, a sliding-slot 340, and an immobilizing slab 350. The panel 310 is attached to the base 330 by the sliding-slot 340. By employing the sliding-slot 340, the user can conveniently replace the panel 310 with different patterns. The panel 310 comprises a transparent area 312 and a non-transparent area 314, and the transparent are 312 forms the pattern to be displayed. The base 330 is comprised of an upper case 331 and a lower case 333. The immobilizing slab 350 is placed between the panel 310 and the optical fabric 320.

FIG. 3B is an assembly diagram illustrating the illuminating textile device 300 according to the second preferred embodiment of the present invention. The base 330 is comprised of the upper case 331 and the lower case 333. The sliding-slot 340 is on the upper case 331. The upper case 331 and the lower case 333 can be assembled by screws or bolts. The optical fabric 320 is placed between the upper case 331 and the lower case 333, and is woven from threads 322 and fiber optics 324. Several fiber optics 324 merge into a bundle 326, and provide the bundle 326 with LEDs as a light source for the fiber optics 324. The bundle 326 is further connected to a switch and an AC source or a battery module, such as a dry battery or a solar battery. The bundle 326 is accommodated in the trench 332 of the base 330.

Further, an immobilizing slab 350 is placed on the optical fabric 320 for immobilizing the optical fabric 320 on the lower case 333. The immobilizing slab 350 prevents the optical fabric 320 from sliding on the lower case 333. The immobilizing slab 350 is fastened to the upper case 331 and the lower case 333 via the screw holes 351 on the corners of the immobilizing slab 350.

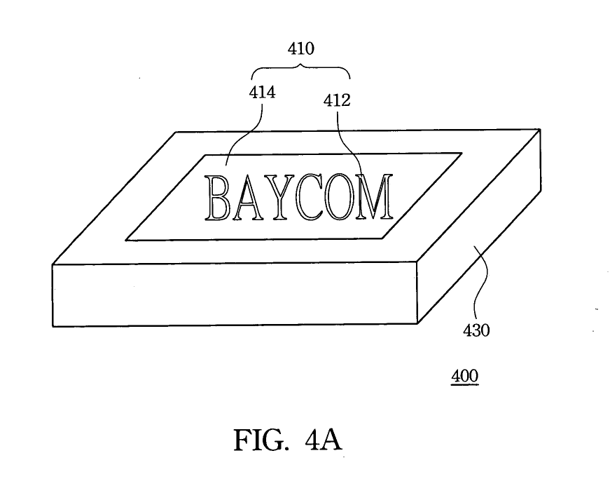

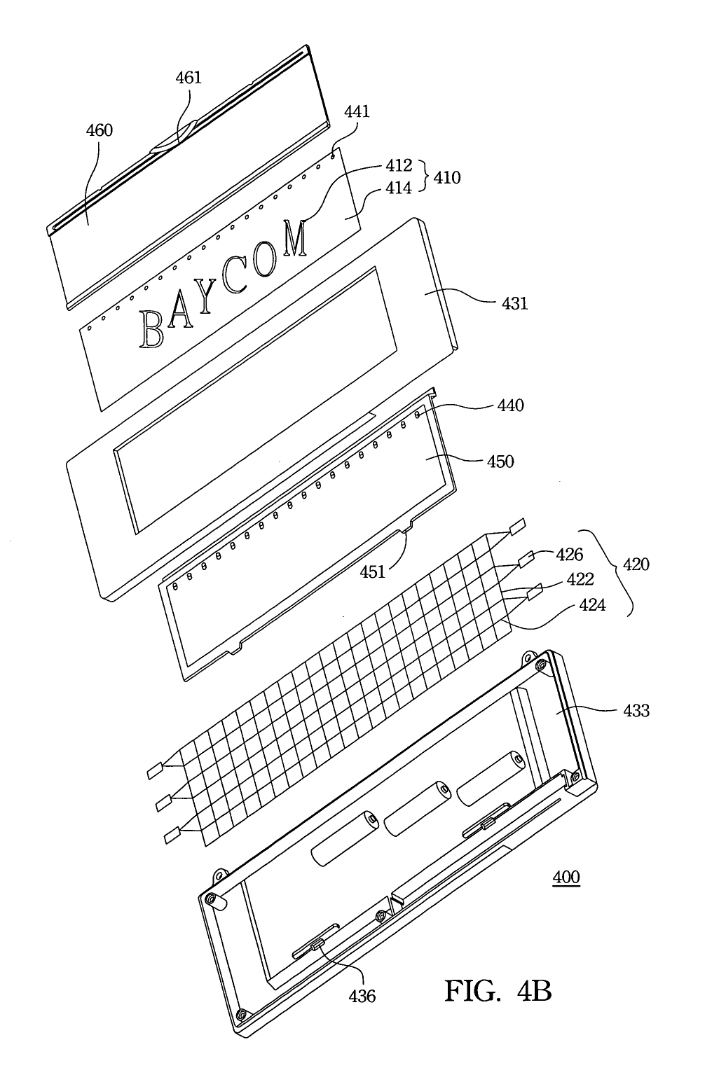

FIG. 4A and 4B illustrate an illuminating textile device according to the third preferred embodiment of the present invention. The illuminating textile device according to the third preferred embodiment of the present invention can be employed in various applications, such as traffic signs, indicators, license plates, route signs, doorplates, decorations, signboards, neon lamps, kites, or toys. FIG. 4A is a top view diagram of the illuminating textile device 400 according to the third preferred embodiment of the present invention. The illuminating textile device 400 comprises a panel 410, a base 430, an optical fabric 420, bolts 440, and immobilizing slab 450 shown in FIG. 4B. The panel 410 is buckled to the base 430 and can be conveniently replaced with different patterns. The panel 410 is comprised of a transparent area 412 and a non-transparent area 414, and the transparent area 412 forms the pattern to be displayed. FIG. 4B is an assembly diagram of the illuminating textile device 400 according to the third preferred embodiment of the present invention. The base 430 is comprised of an upper case 431 and a lower case 433. The upper case 431. and the lower case 433 can be assembled by bolts or screws. The immobilizing slab 450 is used for immobilizing the optical fabric 420, and is fastened to the trench 436 of the lower case 433 via the tenons 451. The optical fabric 420 is placed between the immobilizing slab 450 and the lower case 433, and is woven from the threads 422 and the fiber optics 424. Several fiber optics 424 merge into a bundle 426. A switch and LEDs are provided in the bundle 426 as the light source for the fiber optics 424. The bundle 426 is connected to a switch and an AC source or a battery module, such as a dry battery or a solar battery.

Bolts 440 on the immobilizing slab 450 are inserted into the corresponding holes 441 on the panel 410 to fasten the panel 410 on the immobilizing slab 450. Further, a protective slab 460 is buckled to the upper case 431 by buckles 461. The protective slab 460 protects the panel 410 from damage.

Furthermore, in the embodiments described above, a homogenizing material, such as rice paper or a transparent film, can be placed between the panel and the optical fabric to homogenize the light emitted by the optical fabric. Further, a protective component, such as the protective slab described in the third preferred embodiment or a protective film can be placed on the panel to protect the panel from damage or corrosion.

The illuminating textile device according to the present invention has sustained lifetime and decreased volume, and can be employed in various applications, such as traffic signs, indicators, license plates, route signs, doorplates, decorations, signboards, neon lamps, kites, or toys.

It will be apparent to those skilled in the art that various modifications and variations can be made to the structure of the present invention without departing from the scope or spirit of the invention. In view of the foregoing, it is intended that the present invention panel modifications and variations of this invention provided they fall within the scope of the following claims and their equivalents.

What is claimed is:

1. An illuminating textile device, the illuminating textile device comprising:
a panel having a pattern to be displayed;
an optical fabric woven from a plurality of fiber optics and a plurality of threads for providing a light source for the illuminating textile device; and
a base for supporting the panel and the optical fabric, the base fastening to the panel via a fixation component, and the optical fabric being between the base and the panel.

2. The illuminating textile device of claim 1, wherein the illuminating textile device is a traffic sign, an indicator, a license plate, a route sign, a doorplate, a decoration, a signboard, a neon lamp, a kite, or a toy.

3. The illuminating textile device of claim 1, wherein the pattern of the panel is comprised of a transparent area and a non-transparent area.

4. The illuminating textile device of claim 1, wherein the panel is made of plastic or metal.

5. The illuminating textile device of claim 1, wherein the optical fabric comprises the fiber optics and the threads in horizontal, and the threads in vertical.

6. The illuminating textile device of claim 1, wherein the threads are transparent yarns or reflective yarns.

7. The illuminating textile device of claim 1, wherein the fiber optics merge into a plurality of bundles, each of the bundles containing at least one LED.

8. The illuminating textile device of claim 7, wherein the bundles are in the base.

9. The illuminating textile device of claim 7, wherein the bundles are in at least one trench of the base.

10. The illuminating textile device of claim 1, wherein the fixation component is a screw, a sliding-slot, a buckle, a bolt, a button, or a Velcro.

11. The illuminating textile device of claim 1, wherein the optical fabric is powered by an AC source or a battery module.

12. The illuminating textile device of claim 11, wherein the battery module is a dry battery or a solar battery.

13. The illuminating textile device of claim 1, further comprising a homogenizing material for homogenizing light emitted by the optical fabric.

14. The illuminating textile device of claim 13, wherein the homogenizing material is between the panel and the optical fabric.

15. The illuminating textile device of claim 13, wherein the homogenizing material is rice paper or a transparent film.

16. The illuminating textile device of claim 1, wherein the base comprises an upper case and a lower case.

17. The illuminating textile device of claim 1, further comprising a immobilizing slab for immobilizing the optical fabric.

18. The illuminating textile device of claim 1, further comprising a protective component for protecting the panel.

19. The illuminating textile device of claim 18, wherein the protective component is a protective film or a protective slab.
